(19) United States
(12) Patent Application Publication
(10) Pub. No.: US 2024/0306267 A1
(43) Pub. Date: Sep. 12, 2024

(54) Heater and Heating Unit

(71) Applicant: Tyco Electronics (Shanghai) Co., Ltd., Shanghai (CN)

(72) Inventors: Zhen Wang, Shanghai (CN); Yiqun (Cham) Zhu, Shanghai (CN)

(73) Assignee: Tyco Electronics (Shanghai) Co., Ltd., Shanghai (CN)

(21) Appl. No.: 18/596,832

(22) Filed: Mar. 6, 2024

(30) Foreign Application Priority Data
Mar. 7, 2023 (CN) 202320423811.7

(51) Int. Cl. H05B 3/44; H05B 3/06

(52) U.S. Cl. CPC H05B 3/44; H05B 3/06

(57) ABSTRACT

A heater comprises a housing, multiple heating tubes arranged in the housing, a pair of retaining members installed in the housing, and a single heating wire. The housing has two opposite ends in a longitudinal direction thereof, with the heating tubes arranged in a row along the longitudinal direction. Each retaining member is strip shaped, with one of the pair of retaining members holding first ends of each of the multiple heating tubes, and the other of the pair of retaining members holding second ends of each of the multiple heating tubes. The single heating wire passes through the multiple heating tubes in sequence.

### CROSS-REFERENCE TO RELATED APPLICATION

This application claims the benefit of Chinese Patent Application No. CN202320423811.7 filed on Mar. 7, 2023, in the State Intellectual Property Office of China, the whole disclosure of which is incorporated herein by reference.

### FIELD OF THE INVENTION

The present invention relates to a heater and a heating unit comprising the heater, in particular to a heater and a heating unit for heating a heat shrink tube on a cable.

### BACKGROUND

In the prior art, the heating unit of a heat shrink machine typically includes two plate shaped heaters, and more specifically, an upper and a lower heater. In the prior art, a heating region with uniform temperature in the heating unit is limited to the middle region of the heating unit, resulting in its two ends being unable to be used for heating the heat shrink tube. This not only reduces production efficiency but also unnecessarily increases or wastes energy consumption. In addition, in the prior art, due to structural limitations, the density of the heating wire at both ends of the heater cannot be increased. This results in a temperature at both ends of the heating unit always being lower than a middle temperature. This in turn prevents its two ends from being used for heating the heat shrink tube, affecting the improvement of production efficiency.

In the prior art, the normal operating temperature of the heater of the heat shrink machine is between 500-600° C., and the temperature difference with the external environment is too large. As a result, during heating, heat will be lost through the openings at both ends of the upper and lower heaters, resulting in lower temperatures at the edges of the two ends of the heater, which further leads to uneven heating.

In current technology, the heater structure is relatively simple, making it difficult to achieve a differentiated arrangement of heating wires, and the processing cost is high. For example, in the prior art, only a piece of quartz glass is used to cover the heating wire. The heating wire is in sheet shape and requires precision machining to ensure consistent width. Once the heating wire is processed and formed, it is difficult to adjust it as needed. It is also difficult to ensure the uniformity of the heating wire during installation.

### SUMMARY

According to one embodiment of the present disclosure, a heater comprises a housing, multiple heating tubes arranged in the housing, a pair of retaining members installed in the housing, and a single heating wire. The housing has two opposite ends in a longitudinal direction thereof, with the heating tubes arranged in a row along the longitudinal direction. Each retaining member is strip shaped, with one of the pair of retaining members holding first ends of each of the multiple heating tubes, and the other of the pair of retaining members holding second ends of each of the multiple heating tubes. The single heating wire passes through the multiple heating tubes in sequence.

### BRIEF DESCRIPTION OF THE DRAWINGS

The invention will now be described by way of example with reference to the accompanying Figures, of which:

FIG. 1 shows an illustrative perspective view of a heating unit according to an exemplary embodiment of the present invention;

FIG. 2 shows an illustrative perspective view of a heater according to an exemplary embodiment of the present invention;

FIG. 3 shows an illustrative exploded view of a heater according to an exemplary embodiment of the present invention;

FIG. 4 shows a vertical cross-sectional view of a heater according to an exemplary embodiment of the present invention;

FIG. 5 shows a vertical cross-sectional view of a heater according to an exemplary embodiment of the present invention;

FIG. 6 shows a horizontal cross-sectional view of a heater according to an exemplary embodiment of the present invention, wherein the heating wire is not shown; and

FIG. 7 shows a horizontal cross-sectional view of a heater according to an exemplary embodiment of the present invention, wherein the heating wire is shown.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to one embodiment of the present disclosure, a heater comprises a housing having two opposite ends in its longitudinal direction, multiple heating tubes provided in the housing and arranged in a row along the longitudinal direction of the housing, a pair of retaining members installed in the housing, and a single heating wire passing through the multiple heating tubes in sequence. The retaining member is in a strip shape. One of the pair of retaining members is configured to holding one ends of the row of heating tubes. The other of the pair of retaining members is configured to holding the other ends of the row of heating tubes.

According to another embodiment of the present disclosure, a heater comprises a housing having two opposite ends in its longitudinal direction, multiple heating tubes provided in the housing, and a single heating wire passing through the multiple heating tubes in sequence. The heating tubes extend along a horizontal direction of the housing. Multiple heating tubes are arranged in a row along the longitudinal direction of the housing. An arrangement density of the heating tubes in two end regions near the two ends of the housing is greater than an arrangement density of the heating tubes in a middle region between the two end regions of the housing.

According to another embodiment of the present disclosure, a heating unit comprises an installation bracket, and a pair of heaters installed on the installation bracket. The pair of heaters are spaced from each other and parallel to each other in a height direction perpendicular to a transverse direction and a longitudinal direction of the heater.

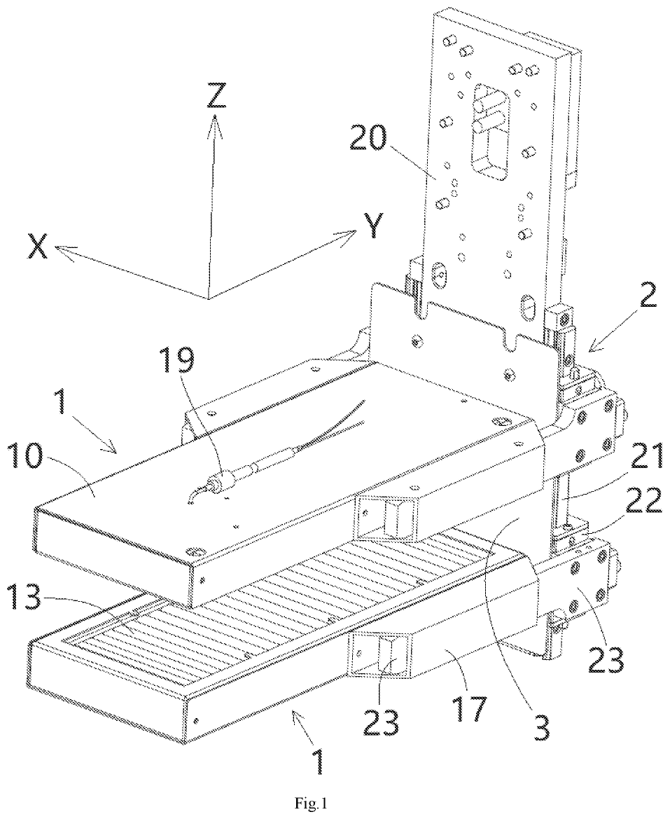

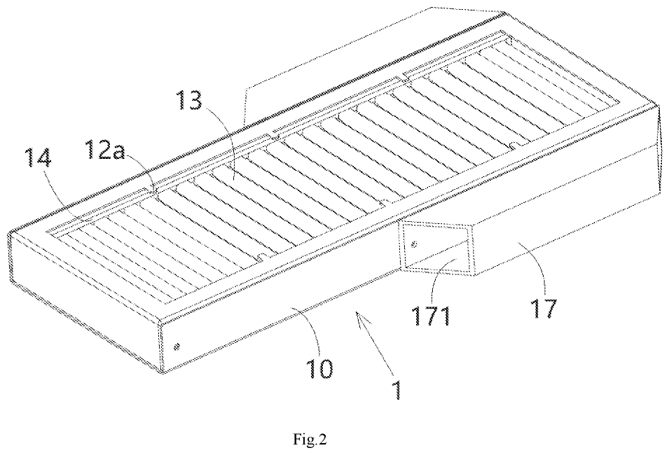

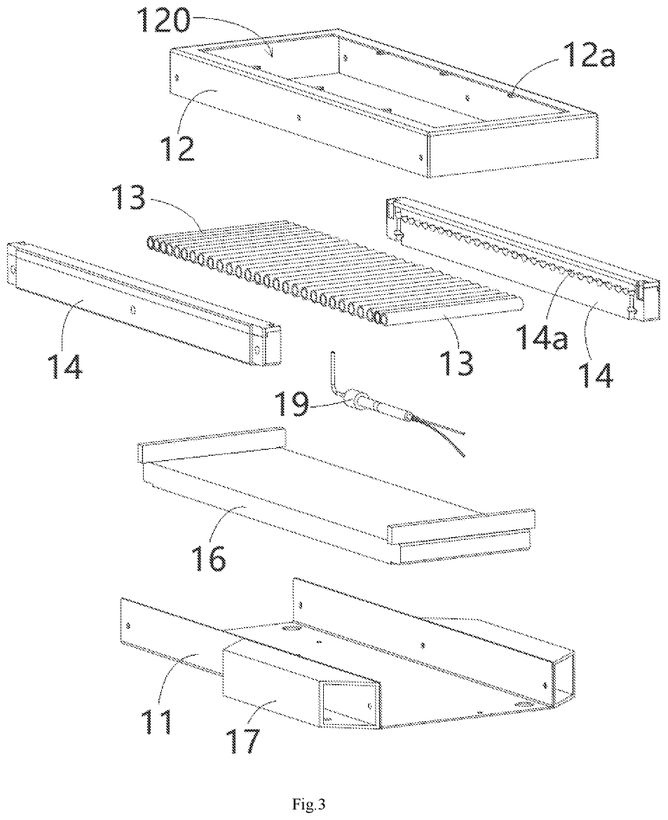

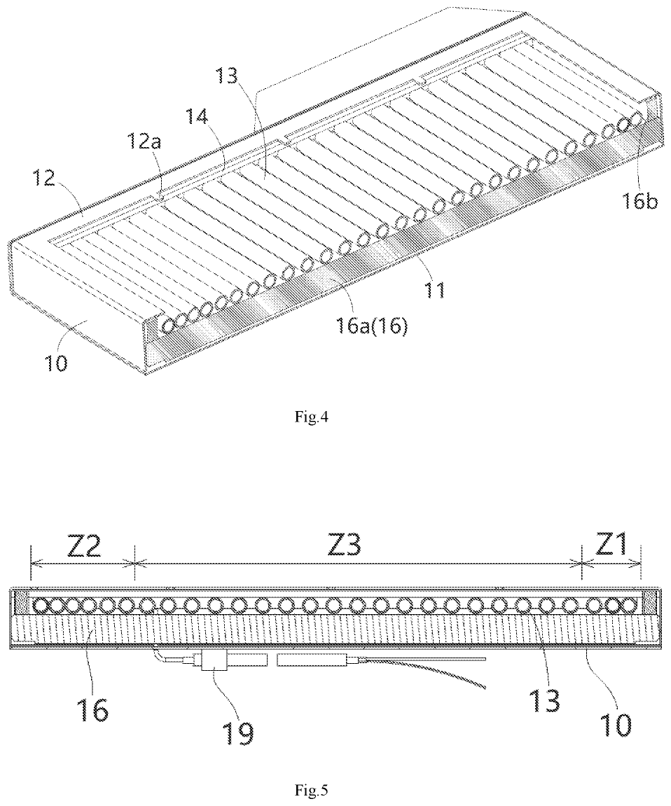

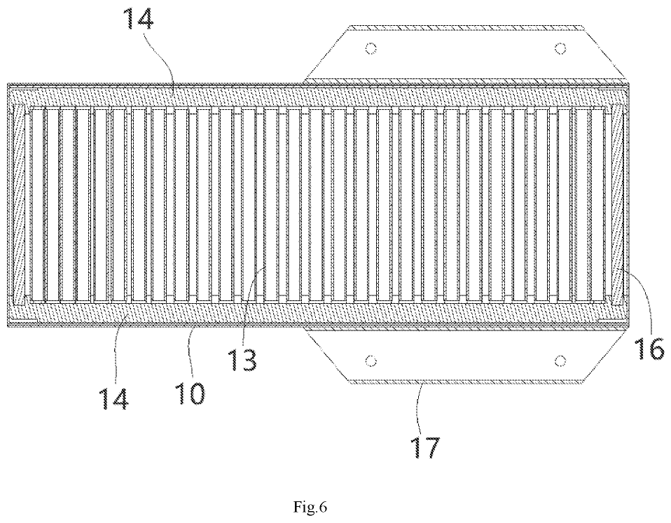

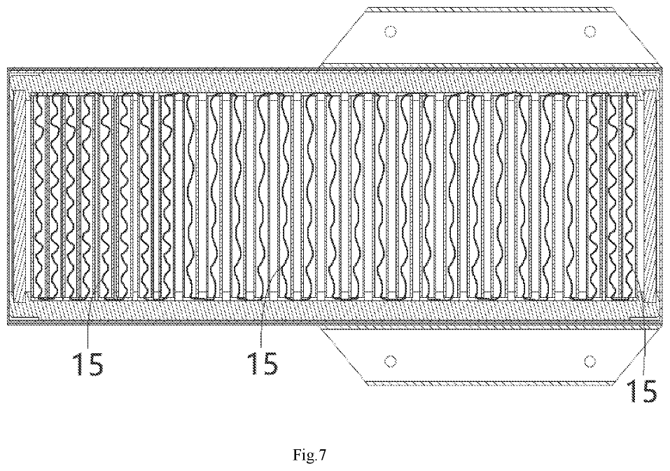

FIG. 1 shows an illustrative perspective view of a heating unit according to an exemplary embodiment of the present invention. FIG. 2 shows an illustrative perspective view of a heater 1 according to an exemplary embodiment of the present invention. FIG. 3 shows an illustrative exploded view of the heater 1 according to an exemplary embodiment of the present invention. FIG. 4 shows a vertical cross-sectional view of the heater 1 according to an exemplary embodiment of the present invention. FIG. 5 shows a vertical cross-sectional view of the heater 1 according to an exemplary embodiment of the present invention. FIG. 6 shows a horizontal cross-sectional view of the heater 1 according to an exemplary embodiment of the present invention, wherein a heating wire (e.g., a heating wire 15) is not shown. FIG. 7 shows a horizontal cross-sectional view of the heater 1 according to an exemplary embodiment of the present disclosure wherein the heating wire 15 is shown.

As shown in FIGS. 1 to 7, in the illustrated embodiments, the heater 1 mainly comprises a housing 10, multiple heating tubes 13, and a single heating wire 15. The housing 10 has two opposite ends in its longitudinal direction Y. Multiple heating tubes 13 are arranged in the housing 10. The single heating wire 15 passes through multiple heating tubes 13 in sequence. The heating tube 13 extends along a horizontal direction X of the housing 10. Multiple heating tubes 13 are arranged in a row along the longitudinal direction Y of the housing 10. The arrangement density of heating tubes 13 in two end regions Z1 and Z2 near two ends of housing 10 is higher than that of the heating tubes 13 in a middle region Z3 between the two end regions Z1 and Z2 of housing 10.

In the illustrated embodiments, the length of the heating wire 15 set in the heating tube 13 in the end regions Z1 and Z2 is greater than the length of the heating wire 15 set in the heating tube 13 in the middle region Z3. In the illustrated embodiment, the heating wire 15 can be in the shape of a spiral spring, and the pitch of the heating wire 15 in the heating tubes 13 in the end regions Z1 and Z2 is smaller than that in the heating tubes 13 in the middle region Z3. In this way, the length of the heating wire 15 in the heating tubes 13 in the end regions Z1 and Z2 is greater than the length of the heating wire 15 in the heating tubes 13 in the middle region Z3.

One end of the housing 10 is adapted to be installed on an installation bracket 20. The two end regions Z1 and Z2 include a first end region Z1 near one end of the housing 10 and a second end region Z2 near the other end of the housing 10. The arrangement density of heating tubes 13 in the first end region Z1 is less than or equal to the arrangement density of the heating tubes 13 in the second end region Z2. The length of the heating wire 15 set in the heating tube 13 in the first end region Z1 is less than or equal to the length of the heating wire 15 set in the heating tube 13 in the second end region Z2.

The heater 1 further comprises a pair of retaining members 14 arranged in the housing 10 to maintain the two ends of the row of heating tubes 13. The retaining member 14 is in a strip shape. One of the pair of retaining members 14 is adapted to hold ends of the row of heating tubes 13. The other of the pair of retaining members 14 is adapted to hold the other ends of the row of heating tubes 13.

The housing 10 has two opposite side walls in its transverse direction X. The pair of retaining members 14 are respectively fixed to the inner sides of the two side walls of the housing 10. The retaining member 14 extends along the longitudinal direction Y of the housing 10. A row of positioning grooves 14a corresponding to the row of heating tubes 13 are formed on the retaining member 14. The two ends of heating tubes 13 are respectively held in the pair of positioning grooves 14a of the pair of retaining members 14.

The heater 1 further includes a heat insulation pad 16 provided between the housing 10 and the heating tubes 13 to prevent heat from being transferred from the heating tubes 13 to the housing 10. The heat insulation pad 16 comprises a first heat insulation pad 16a and a second heat insulation pad 16b. The first heat insulation pad 16a is set between the bottom wall of the housing 10 and the row of heating tubes 13. The second heat insulation pad 16b is set between the end wall of the housing 10 and the heating tube 13 at the end of the housing 10.

A window 120 is formed on the top wall of the housing 10, and the heat of the heating tubes 13 radiates outward through the window 120 to heat an object to be heated. A plurality of positioning tongues 12a are formed on the edge of the window 120 of the housing 10. The positioning tongues 12a are pressed against the top surface of the retaining member 14 to limit the position of the retaining member 14 in the height direction Z. The housing 10 comprises a lower housing 11 and an upper housing 12 assembled together. The window 120 and the positioning tongues 12a are formed on the top wall of the upper housing 12.

The heater 1 further includes a temperature sensor 19. The sensor 19 is installed on the bottom wall of the housing 10 and extends into the housing 10 to detect the temperature of the heating tube 13. In an embodiment, the temperature sensor 19 can be a thermocouple.

The heater 1 further comprises a pair of mounting members 17 respectively fixed to both sides of one end of housing 10, for installing the heater 1 onto the installation bracket 2. A socket 171 is formed in the mounting member 17 for matching with a plug 23 on the installation bracket 2, allowing the heater 1 to be quickly installed on the installation bracket 2 in a plug-in manner.

As shown in FIGS. 1 to 7, in another exemplary embodiment of the present invention, a heating unit is also disclosed. The heating unit mainly includes an installation bracket 2 and a pair of the heaters 1. The pair of heaters 1 are installed on installation bracket 2. The pair of heaters 1 are spaced from each other and parallel to each other in the height direction Z perpendicular to the transverse direction X and the longitudinal direction Y of the heater 1. At least one of the pair of heaters 1 is movably installed on the installation bracket 2, so that the spacing between the pair of heaters 1 can be adjusted to fit the size of the object (not shown) to be heated.

The installation bracket 2 mainly includes a mounting plate 20, a guide rail 21, a slider 22, and a plug 23. The installation plate 20 extends along the transverse direction X and the height direction Z of the housing 10. The guide rail 21 extends in a straight line along the height direction Z and is fixed to the mounting plate 20. The slider 22 is slidably installed on the guide rail 21. The plug 23 extends along the longitudinal direction Y of the housing 10 and is fixed to the slider 22. The plug 23 is inserted into the socket 171 of mounting member 17 of the heater 1, so that the heater 1 can be moved along guide rail 21 with the slider 22.

The heating unit further comprises a heat reflection plate 3. The heat reflection plate 3 is set on an opening at one ends of the pair of heaters 1 and fixed to the installation bracket 2. The heat reflection plate 3 is used to reflect heat into the heating region between the pair of heaters 1, in order to prevent heat from flowing from the opening at one ends of the pair of heaters 1 to the outside of the heating region.

In the aforementioned exemplary embodiments of the present invention, the installation of the heating wire and heating tube can be achieved by sequentially passing a single heating wire through multiple heating tubes and positioning the two ends of the multiple heating tubes on the pair of retaining members, which is very convenient.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A heater, comprising:
a housing having two opposite ends in a longitudinal direction of the housing;
multiple heating tubes provided in the housing and arranged in a row along the longitudinal direction of the housing;
a pair of retaining members installed in the housing, each retaining member being strip shaped, one of the pair of retaining members holding first ends of each of the multiple heating tubes, and the other of the pair of retaining members holding second ends of each of the multiple heating tubes; and
a single heating wire passing through the multiple heating tubes in sequence.

2. The heater according to claim 1, wherein the housing has two opposite side walls in a transverse direction, and the pair of retaining members are respectively fixed to inner sides of the two side walls of the housing.

3. The heater according to claim 2, wherein the retaining member extends in the longitudinal direction of the housing, and a row of positioning grooves corresponding to the row of heating tubes are formed on the retaining member.

4. The heater according to claim 3, wherein the first and second ends of the heating tubes are respectively held in the positioning grooves of the pair of retaining members.

5. The heater according to claim 4, wherein a window is formed on the top wall of the housing and is adapted such that heat from the heating tube may radiate outward through the window to heat an object to be heated.

6. The heater according to claim 5, wherein a positioning tongue is formed on the edge of the window of the housing and is pressed against the top surface of the retaining member to limit the position of the retaining member in a height direction of the housing.

7. The heater according to claim 6, wherein the housing includes a lower housing and an upper housing assembled together, and the window and the positioning tongue are formed on the top wall of the upper housing.

8. The heater according to claim 1, further comprising a pair of mounting members respectively fixed to both sides of one end of the housing and adapted to enable installation of the heater onto an installation bracket.

9. The heater according to claim 8, wherein a plug-in socket is formed on the mounting member and adapted to engage with a plug arranged on the installation bracket.

10. The heater according to claim 1, further comprising a heat insulation pad arranged between the housing and the heating tube and adapted to prevent heat from being transferred from the heating tube to the housing.

11. The heater according to claim 10, wherein the heat insulation pad includes:
a first heat insulation pad arranged between the bottom wall of the housing and the row of heating tubes; and
a second heat insulation pad arranged between the end wall of the housing and the heating tube at the end of the housing.

12. The heater according to claim 1, further comprising a temperature sensor installed on the bottom wall of the housing and extending into the housing to detect the temperature of the heating tube.

13. The heater according to claim 1, wherein an arrangement density of the heating tubes in two end regions proximate the two ends of the housing is greater than an arrangement density of the heating tubes in a middle region between the two end regions of the housing.

14. A heating unit, comprising:
an installation bracket; and
a pair of heaters installed on the installation bracket, the pair of heaters spaced from each other and parallel to each other in a height direction perpendicular to a transverse direction and a longitudinal direction of the heater, each heater including:
a housing having two opposite ends in the longitudinal direction;
multiple heating tubes provided in the housing and arranged in a row along the longitudinal direction;
a pair of retaining members installed in the housing, each retaining member being strip shaped, one of the pair of retaining members holding first ends of each of the multiple heating tubes, and the other of the pair of retaining members holding second ends of each of the multiple heating tubes; and
a single heating wire passing through the multiple heating tubes in sequence.

15. The heating unit according to claim 14, wherein at least one of the pairs of heaters is movably mounted on the installation bracket such that the spacing between the pairs of heaters is adjustable to fit the size of an object to be heated.

16. The heating unit according to claim 14, wherein the installation bracket comprises:
a mounting plate extending along the transverse direction and a height direction of the housing;
a guide rail extending in a straight line along the height direction and is fixed to the mounting plate; and
a slider slidably installed on the guide rail.

17. The heating unit according to claim 16, wherein the plug is inserted into the socket of the mounting member of the heater such that the heater is movable with the slider along the guide rail.

18. The heating unit according to claim 16, wherein the installation bracket further comprises a plug extending along the longitudinal direction of the housing and fixed to the slider.

19. The heating unit according to claim 14, further comprising a heat reflection plate provided on an opening at one ends of the pair of heaters and fixed to the installation bracket.

20. The heating unit according to claim 19, wherein the heat reflection plate is adapted reflect heat into a heating region between the pair of heaters and adapted to prevent heat from flowing from the opening at one ends of the pair of heaters to the outside of the heating region.
